(19) United States
(12) Patent Application Publication
(10) Pub. No.: US 2025/0327676 A1
(43) Pub. Date: Oct. 23, 2025

(54) INTERCONNECTING AND TRACKING GROUPS FOR SAFE TRAVEL AND RELATED SYSTEMS AND METHODS

(71) Applicant: TETHER LLC, Twin Falls, ID (US)

(72) Inventor: Randy Scott Martin, Twin Falls, ID (US)

(21) Appl. No.: 18/857,800

(22) PCT Filed: May 1, 2023
(86) PCT No.: PCT/US2023/020582

§ 371 Date: Oct. 17, 2024

Related U.S. Application Data
(60) Provisional application No. 63/337,529, filed on May 2, 2022.
(60) Provisional application No. 63/425,993, filed on Nov. 16, 2022.

(51) Int. Cl. G01C 21/34

(52) U.S. Cl. CPC G01C 21/3438; G01C 21/343

(57) ABSTRACT

Systems and methods for directing a plurality of group members along a route are disclosed herein. In some embodiments. the method includes receiving a continuous stream of global positioning system (GPS) signals from the mobile device associated with each member of the group and continuously determining a real-time position of each member using the of GPS signals, including a selected leader for the group. For each other member (e.g., non-leader). the method also includes planning a route from the other member to the leader based on the real-time position of the other member, the real-time position of the leader (and/or a projected position of the leader over time), and/or any other suitable information. Once the route is planned, the method includes sending the route to the mobile device associated with the other member and tracking each member along the route.

### CROSS-REFERENCE TO RELATED APPLICATIONS

The present application claims the benefit of U.S. Provisional Patent Application No. 63/337,529, filed May 2, 2022, and U.S. Provisional Patent Application No. 63/425,993, filed Nov. 16, 2022, both of which are incorporated herein by reference in their entireties.

### TECHNICAL FIELD

The present technology is generally directed to systems and methods for tracking the geographic location of tethered individuals and generating mutual directions for the same.

### BACKGROUND

Group travel can be difficult to plan and manage while moving. Typical mapping, global positioning systems (GPS), and guidance systems allow users to input final destinations, then receive guidance to the final destinations that are specific to each member of the group. For example, members of the group often get side-tracked, delayed by traffic and/or traffic control devices, lost, or otherwise diverted for various reasons, and the guidance systems can reroute the members to the final destinations. However, the diversions can cause every member of the group to be delayed at a destination and/or can throw off the coordination of the group. Further, the diversions can result from serious safety concerns (e.g., traffic accidents) that may require the attention of the group. Still further, the systems do not offer any safety features to members of the group while at a given location.

### BRIEF DESCRIPTION OF THE DRAWINGS

FIG. 1 is a block diagram illustrating an overview of devices on which some embodiments of the present technology can operate.

FIG. 2 is a block diagram illustrating an overview of an environment in which some embodiments of the present technology can operate.

FIG. 3 is a block diagram illustrating components of a computing device configured in accordance with some embodiments of the present technology.

FIG. 4 is a flow diagram of a process for directing a plurality of group members to a leader in accordance with some embodiments of the present technology.

FIG. 5 is a flow diagram of a process for planning a route for a group in accordance with some embodiments of the present technology.

FIG. 6 is a flow diagram of a process for reacting to detected events impacting group safety in accordance with some embodiments of the present technology.

FIG. 7 is a flow diagram of a process for reacting to a diversion from a group member in accordance with some embodiments of the present technology.

FIGS. 8A-8J illustrate user interfaces for linking and tracking group members and reacting to safety hazards in accordance with some embodiments of the present technology.

The drawings have not necessarily been drawn to scale. Similarly, some components and/or operations can be separated into different blocks or combined into a single block for the purpose of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described.

As used herein, “real-time” refers to processing input information and/or input data within a time constraint (e.g., before an actual geographic position of someone can change so much that they cannot be located at a determined geographic location) such that the processed information is available virtually immediately and/or in time to be used by the system. Real-time is typically understood to mean processing on the order of milliseconds or microseconds.

### DETAILED DESCRIPTION

### A. Overview

Systems and methods for directing a plurality of group members along a route (e.g., to a leader of the group) are disclosed herein. In some embodiments, the method includes receiving a continuous stream of global positioning system (GPS) signals from a mobile device associated with the leader (sometimes also referred to herein as a “lead member”) and continuously determining a real-time position of the leader using the of GPS signals. For each other member of the group, the method also includes receiving a continuous stream of GPS signals from a mobile device associated with the other member, continuously determining a real- time position of the other member using the GPS signals, and planning a route from the other member to the leader (or another suitable location) based on the real-time position of the other member, the real-time position of the leader (and/or a projected position of the leader over time), and/or any other suitable information. Once the route is planned, the method includes sending the route to the mobile device associated with the other member (e.g., to be displayed on a user interface at the mobile device).

In some embodiments, the method can execute each of these steps continuously to track the positions of the members of the group and continuously (e.g., dynamically) update the routes to direct the members to the leader (or any other suitable destination). The dynamic updates can account for changing traffic conditions (accidents, traffic slowdowns, temporary closures, and the like), the changing positions of members of the group (e.g., accounting for wrong turns by members traveling along the route, accounting for the movement of the leader if set as the destination, and the like), changing weather conditions, changing destinations, member preferences (e.g., preference to avoid tolls, take highways instead of side streets, and the like), and/or various other suitable conditions. In various embodiments, the method updates the route at least every hundred milliseconds, every half second, every one, two, three, five, ten or any other suitable number of seconds, every minute, and/or after any other suitable period.

In some embodiments, the method includes sending, to each member of the group, an indication of a real-time position of each other member in the group. In such embodiments, the members can see the position of other members along their route and/or track the location of the other members. The continuous tracking function can allow the group to see when a member gets held up, deviates from the route, and/or is potentially in distress. The continuous tracking can also allow members to skip one or more destinations while traveling as a group (e.g., sights along the way) and be routed to rejoin the group.

In some embodiments, the method allows the leader (or current destination) to be dynamically altered while traveling. For example, the method can include receiving, from the mobile device associated with the original leader, an indication to update the route to direct the plurality of members to a new leader (e.g., any of the other members, a new member, and the like) and/or to a suitable destination. The method can then follow the steps above to receive GPS signals from the mobile device associated with the new leader, determine the real-time position of the new leader, and generate a route for each of the other members based at least partially on the real-time position of the new leader.

In some embodiments, the method includes detecting an event associated with one of the plurality of group members. The event can be a traffic accident, a dropped phone or other impact event, a detected altercation (e.g., based on recorded screaming), a deviation to a rest stop, a deviation to a new destination, a timer-based event at a location (e.g., exceeding a preset maximum time at a location), a deviation outside of a geofenced area (e.g., a set distance around a member of the group, a set distance around a set destination, and the like), an SOS signal, and/or various other events. After detecting the event, the method can include determining the real-time position of the associated member (e.g., using GPS signals from their mobile device), planning a new route for one or more other group members to direct the other group members to the event (e.g., to assist and/or regroup), and sending the new route to the one or more group members.

In some embodiments, the method includes receiving one or more inputs associated with the detected event. For example, the member associated with the detected event can provide a description of the event (e.g., a description of the traffic accident, an indication they accidentally dropped their phone during the detected impact event, they dropped their phone during a struggle or altercation, an indication they are at a rest stop for a short break, inputs related to the new destination, and the like). Additionally, or alternatively, the associated member can indicate their status (e.g., indicate they are caught behind a traffic accident but do not need assistance, they need assistance, they are being held against their will, and the like). In a specific, non-limiting example, the associated member can be required to enter a passcode while providing the inputs related to the event. The passcode can be checked to verify that the member is freely providing the inputs (e.g., an incorrect passcode can indicate a malicious party provided the update, a fake passcode can indicate the member was forced to enter the passcode/provide the updates and needs assistance even if the updates indicated otherwise, and the like)

As one example, the systems and methods described herein can be useful for a real estate agent to guide prospective home buyers to different locations during a showing while also providing the real estate agent with the ability to share their location with another person for their safety. The dynamic route planning can allow, for example, additional homes to be added to the showing on an ad hoc basis and/or can allow the real estate agent to guide prospective buyers through a neighborhood on their way to visit homes (e.g., to show features of the neighborhood, such as public spaces, restaurants, grocery stores, and the like).

Conventional route planning systems typically require users to manually insert endpoint destinations and coordinate to keep a group moving toward the destinations. However, members of the group can get separated along the route: new destinations require each of the members to update the route planning system independently: and it can be difficult for members of the group to respond to other members in distress (e.g., after a traffic accident, when a group member is being held against their will, and the like). The systems and methods disclosed herein overcome these technical deficiencies in conventional systems. For example, as discussed above, each of the members of the group can be provided with a route directly to another member of the group rather than to endpoint destinations. Further, when one of the members of the group is distressed and/or deviates from the route, the other members of the group can be automatically rerouted directly to the distressed member.

Although frequently discussed in the context of a real estate agent working with prospective buyers, one of skill in the art will understand that the scope of the present technology is not so limited. For example, the systems and methods disclosed herein can also be used by families to keep track of children, by friends when traveling together, by school bussing systems, and/or in many other suitable settings. Accordingly, the scope of the present technology is not confined to any subset of the specific examples disclosed herein.

### B. Systems and Methods Tracking Geographic Location(s) of Tethered Individuals and Generating Mutual Directions for the Same

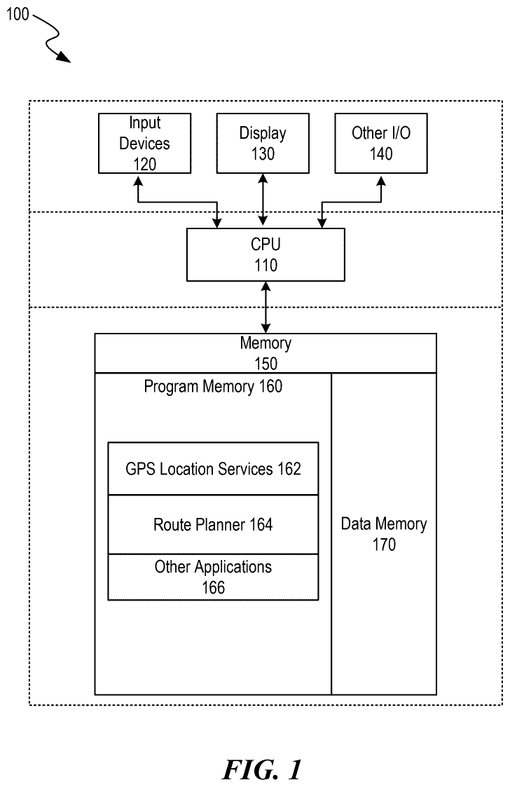

FIG. 1 is a block diagram illustrating an overview of an example of a device 100 on which some embodiments of the present technology can operate. In the illustrated embodiment, device 100 includes one or more input devices 120 that provide input to one or more CPU(s) (processor, “the CPU”) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other suitable user input devices.

The CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. The display 130 can be used to display text and graphics. In some embodiments, the display 130 provides graphical and textual visual feedback to a user. In some embodiments, the display 130 includes the input device as part of the display, such as when the input device is a touchscreen or is equipped with an eye direction monitoring system. In some embodiments, the display is separate from the input device. Examples of display devices include: an LCD display screen, an LED display screen, an OLED display screen, an AMOLED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, Blu-Ray device, and the like.

In some embodiments, the device 100 also includes a communication device capable of communicating wirelessly or wire-based with a network node. The communication device can communicate with another device or a server through a network using, for example, TCP/IP protocols, a Q-LAN protocol, or others. Device 100 can utilize the communication device to distribute operations across multiple network devices.

The CPU 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as a GPS Location Services component 162, a Route Planner component 164, and other application programs 166. Memory 150 can also include data memory 170 that can include data to be operated on by applications, configuration data, settings, options or preferences, etc., which can be provided to the program memory 160 or any element of the device 100.

Some embodiments can be operational with numerous other computing system environments or configurations. Examples of computing systems, environments, and/or configurations that may be suitable for use with the technology include, but are not limited to, personal computers, AVC I/O systems, networked AVC peripherals, video conference consoles, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

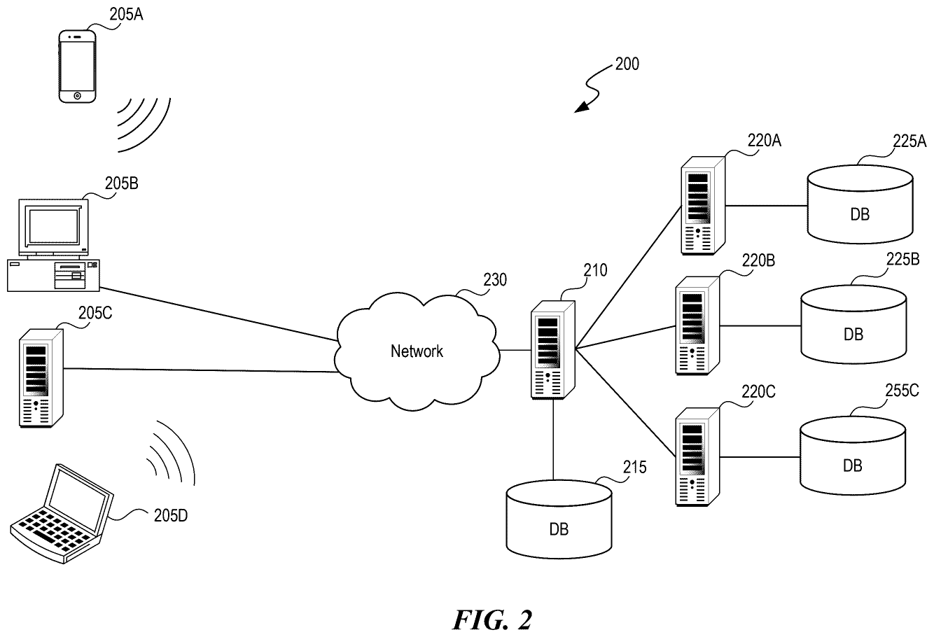

FIG. 2 is a block diagram illustrating an overview of an environment in which some embodiments of the present technology can operate. Environment 200 can include one or more client computing devices 205A-D, examples of which can include device 100. In the illustrated embodiment, device 205A is a wireless smartphone or tablet, device 205B is a desktop computer, device 205C is a computer system, and device 205D is a wireless laptop. These are only examples of some of the devices, and other embodiments can include other computing devices. For example, device 205C can be a server with an OS implementing route planning services for multiple smartphones. The route planning can be based on GPS signals received from each of the mobile devices that are used to identify the absolute position (sometimes also referred to herein as an exact position, with an accuracy of within about ten meters or less) of each of the mobile devices in real time. Additionally, or alternatively, the client computing devices 205 can operate in a networked environment using logical connections through network 230 to one or more remote computers, such as a server computing device 210 to provide these services. In some embodiments, additional computational and/or geographical components can be included in environment 200, such as: one or more third-party servers providing maps of a relevant geographical area, in-field beacons that communicate with the client computing devices 205 using a shortrange wireless protocol (e.g., Bluetooth®) when the client computing devices 205 are within a relevant range, and the like.

In some embodiments, the server computing device 210 is an edge server which receives client requests and coordinates the fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some embodiments, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some embodiments, portions of network 230 can be a LAN or WAN implementing a relevant communication protocol. Portions of network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

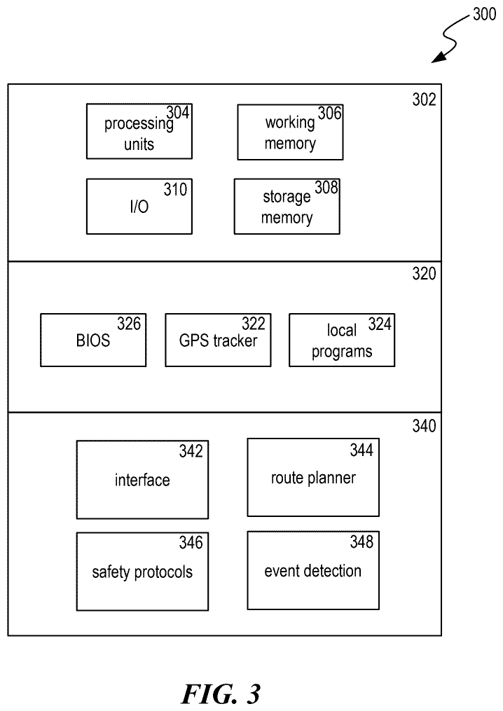

FIG. 3 is a block diagram illustrating components of a computing device configured in accordance with some embodiments of the present technology. The components 300 include hardware 302, general software 320, and specialized components 340. As discussed above, a system implementing the disclosed technology can use various hardware including processing units 304 (e.g., CPUs, GPUs, APUs, etc.), working memory 306, storage memory 308 (local storage or as an interface to remote storage, such as storage 215 or 225), and input and output (I/O) devices 310. In various embodiments, storage memory 308 can be one or more of: local devices, interfaces to remote storage devices, or combinations thereof. For example, storage memory 308 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including a GPS system 322, local programs 324, and a basic input output system (BIOS) 326. In some embodiments, specialized components 340 can be subcomponents of one or more of the general software applications 320, such as the GPS system 322. Specialized components 340 can include a group-based route planner 344, group safety protocols 346, event detection 348, and components which can be used for providing user interfaces, transferring data, and controlling the specialized components, such as interface 342. In some embodiments, components 300 can be in a computing system that is distributed across multiple computing devices or can be an interface to a server-based application executing one or more of specialized components 340.

The group-based route planner 344 can link multiple members of a group together. While linked, group members can be provided with a route to a group leader, one or more other members of the group (e.g., daisy-chaining the group such that a first member is directed to the leader, a second member is directed to the first member, and so on), and/or one or more destinations for the group. By routing members to leader and/or other members, the group-based route planner 344 can improve the safety of the group while traveling (e.g., members are not left behind, are tracked when they deviate from the route, etc.). In some embodiments, the group-based route planner 344 is dynamically updated to switch between leaders, members, and/or destinations while traveling. Purely by way of example, when another component detects a stress event (e.g., a traffic accident, a dropped phone or other impact on the group member, and/or the like) for a first group member, the other members can automatically be re-routed to the first group member to assist. Additionally, or alternatively, the group-based route planner 344 is dynamically updated to account for travel conditions (e.g., traffic, weather, and the like), the real-time location of members (e.g., when deviations due to wrong turns, rest stops, and the like are detected), and group member preferences (e.g., to avoid tolls, take residential roads instead of highways, and the like). Purely by way of example, when one member is detected exiting a highway off the route, the route can be dynamically updated to account for such a deviation.

The group safety protocols 346 can be set by group members and used to monitor group behavior to detect events and/or otherwise trigger the group-based route planner 344. For example, the leader of a group can input the maximum time they want to spend at a destination (e.g., thirty minutes at a home showing) where excess time at the destination can indicate an unsafe environment (e.g., the real estate agent being held against their will at the home showing). In another example, the group members can input a maximum distance they can be away from the group before triggering a notification to other group members.

The event detection 348 module can identify events that indicate one or more group members need attention. For example, the event detection 348 module can use inputs from any of the I/O devices 310 to monitor the environment around the group and/or the movement of group members. Sudden stops, sudden direction changes, loud noises (e.g., yelling, bangs, and the like), rapid temperature changes, sudden input drops (e.g., loss of all GPS data inputs), and the like can indicate events (e.g., traffic accidents, kidnappings, robberies, explosions, weather events, and the like) that are safety hazards for a group member. When the event detection 348 module identifies the events, the event detection 348 module can notify other group members of the event, provide an indication of the detected data (e.g., “sudden stop detected”), and/or route one or more group members to the distressed group member.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some embodiments, one or more of the components described above can execute one or more of the processes described below.

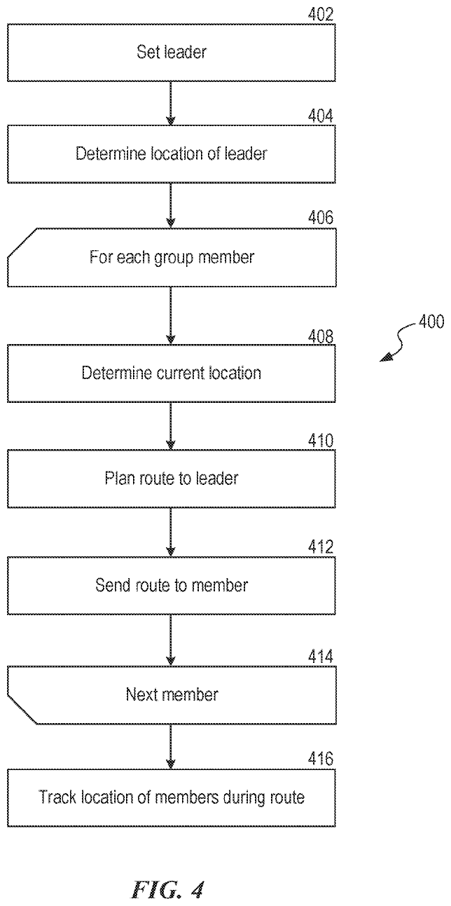

FIG. 4 is a flow diagram of a process 400 for directing a plurality of group members to a leader in accordance with some embodiments of the present technology. The process 400 can be executed to link each of the plurality of group members together and/or to alter the leader (or destination) for a linked group.

The process 400 begins at block 402 by setting a leader for the group. In some embodiments, the leader is automatically set as a user that creates the group. In some embodiments, the leader is set by an indication from one or more members of the group (e.g., by the group member that created the group, by a selection from the group, a transfer from a current leader to a new leader, and the like). In some embodiments, the leader is set in response to a trigger from another process. For example, as discussed in more detail below, a new leader can be set in response to a detected event (e.g., a traffic accident) experienced by a group member.

After a leader is set, at block 404 the process 400 can determine a current location of the leader, a route the leader is traveling one, and/or a destination the leader is traveling toward. For example, the process 400 can receive one or more GPS signals (e.g., GPS signals associated with a specific time, a continuous stream of GPS signals, and the like) from an electronic device associated with the leader (e.g., the leader's smartphone or other mobile device) and use the GPS signals to determine an absolute geographic location of the leader (e.g., within about ten meters, within about five meters, or within about one meter) and/or a direction the leader is traveling in. In another example, the group member's current location can be indicated by one or more beacons or other third-party devices (e.g., network-connected devices that establish shortrange communication with the electronic device associated with the user). In a specific, non-limiting example, a child's current location can be indicated by the mobile device of a bus driver, daycare provider, teacher, and the like. In a specific, non-limiting example, the leader can pass by a beacon in a room of a large building (e.g., a shopping center, commercial building, office building, apartment building, and the like), and the beacon can relay the leader's absolute location in the building through the network. Additionally, or alternatively, the process 400 can receive a route from a mapping component on the mobile device associated with the leader to predict where the leader will be over time and/or a destination the leader is traveling toward.

The process 400 can then loop through blocks 406-414 for each member in the plurality of group members. The loop in blocks 406-414 can route each of the group members to the leader (or another suitable destination). In some embodiments, the loop in blocks 406-414 is executed sequentially for each member. Sequential ordering can be useful, for example, when group members are daisy-chained together (e.g., first member follows the leader, second member follows the first member, and so on) to account for the route for a first member when routing a second member. In some embodiments, the loop in blocks 406-414 is executed simultaneously (or quasi-simultaneously) for each member, allowing each member to quickly receive their route.

At block 408, the process 400 includes determining the current location of the group member. Similar to the discussion above, determining the current location of the group member can include receiving one or more GPS signals from an electronic device associated with the group member and using the GPS signals to determine an absolute geographic location of the group member and/or a direction the group member is currently traveling in (e.g., to project the absolute location as the route is planned and delivered). Additionally, or alternatively, the group member's current location can be indicated by one or more beacons or other third-party devices.

At block 410, the process 400 includes planning a route from the current location of the group member to the leader and/or another suitable destination (e.g., another group member, a destination entered by the leader, and the like). The route can be planned by any suitable mapping software (e.g., Google Maps, MapQuest, Waze, Apple Maps, OsmAnd, OpenStreetMap, and/or any other suitable software) using the current location of the leader and the group member; a continuous, dynamic input of the location of the leader and the group member; and/or a projected location of the leader (e.g., based on current direction of travel, their received route, their received destination, and the like) and the location of the group member. Planning the route can include accounting for traffic, construction, and/or safety hazards between the group member and the leader. Additionally, or alternatively, planning the route can include accounting for safety protocols for the group member (e.g., a preference to walk on main streets, a preference to avoid arterial roads, and the like).

At block 412, the process 400 includes sending the route to the group member. In some embodiments, for example, the route is communicated to the electronic device associated with the group member. In such embodiments, the route can be configured to be displayed on a user interface at the electronic device (e.g., in an associated mapping software and/or within a window of another application on the electronic device). In some embodiments, the route is also configured to display the location of the leader and/or any other group members, the route of the leader, and/or the route provided to any other group member.

At block 414, the process 400 moves to the next group member and returns to block 406. In embodiments that daisy chain group members together, the process 400 can sequentially loop through each of the group members. In other embodiments, the process 400 can loop through blocks 404-414 for each group member simultaneously (e.g., to plan a route between each member of a group to the leader (or other destination) at one time).

At block 416, the process 400 includes tracking the group along the route. As discussed above, each group member's location and/or direction of travel can be tracked using GPS signals from the electronic devices associated with each member of the group and/or information from one or more beacons and/or other third-party devices. Additionally, or alternatively, other I/O components on the electronic devices can provide information to track each member of the group (e.g., audio and/or video inputs, temperature inputs, and the like can track the environment around the group member during their route).

In some embodiments, the process 400 can continuously loop through blocks 404-414 for each group member to provide a continuously updated, dynamic route to each of the group members. Continuous updates can be useful, for example, to help communicate the location of other group members along the route, show how the leader's location has changed, and the like. Purely by way of example, the continuous updates can allow a group to deviate from a route to get food, gas, use the restroom, and the like while automatically communicating updates on their location to the group. Additionally, or alternatively, a leader may determine that another route would be more efficient or safer than a current route. The continuous updates can automatically communicate the deviation to other members and update their routes accordingly. Additionally, or alternatively, the leader can add destinations to the route and the new destinations can be automatically communicated to group members.

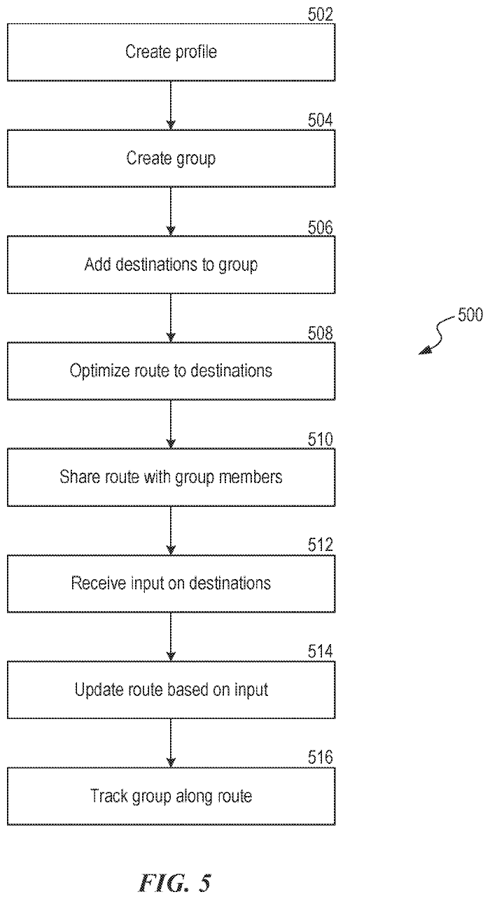

FIG. 5 is a flow diagram of a process 500 for planning a route for a group in accordance with some embodiments of the present technology. The process 500 can be implemented in response to inputs from a user (e.g., the leader of the group) through any of the computing devices discussed above.

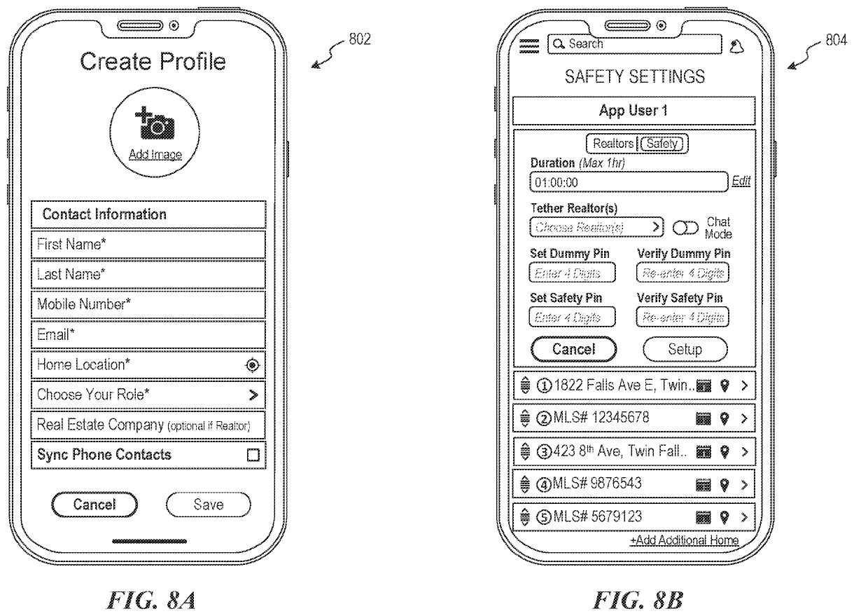

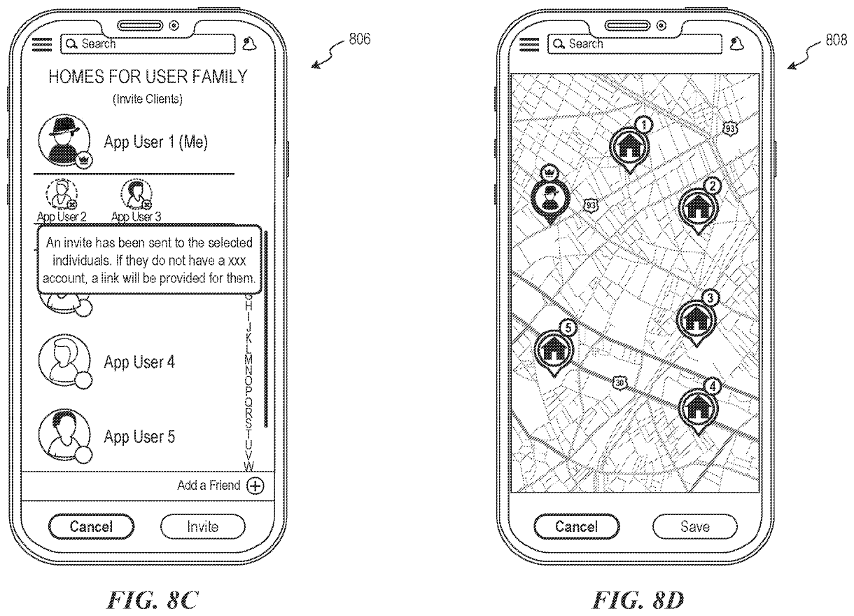

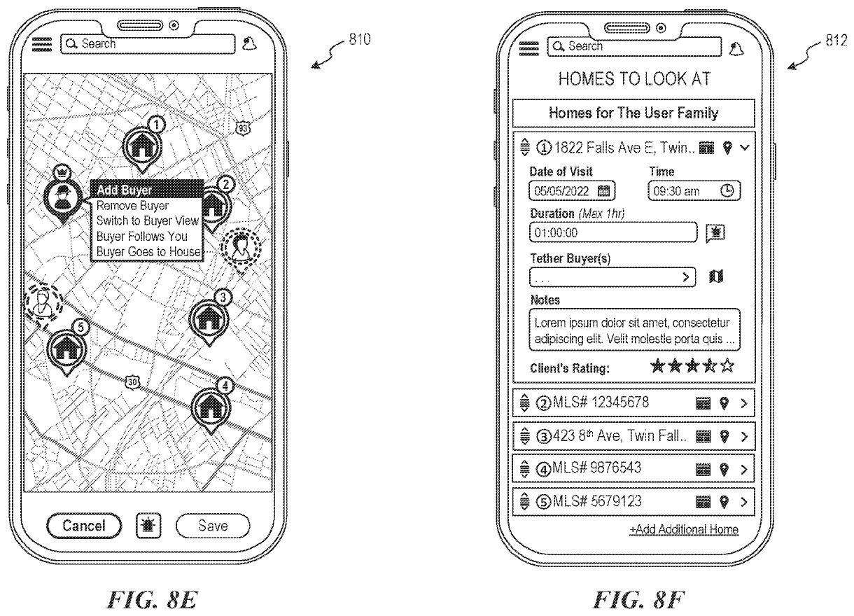

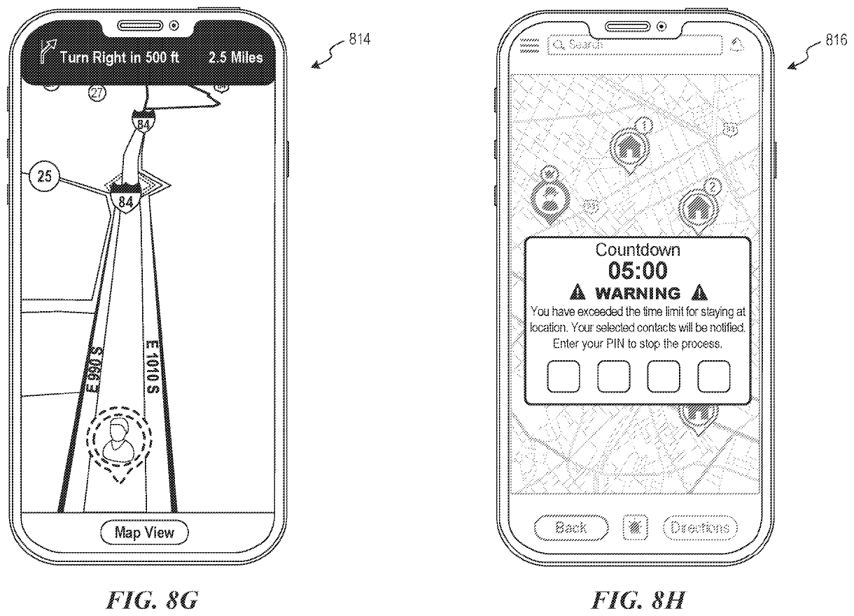

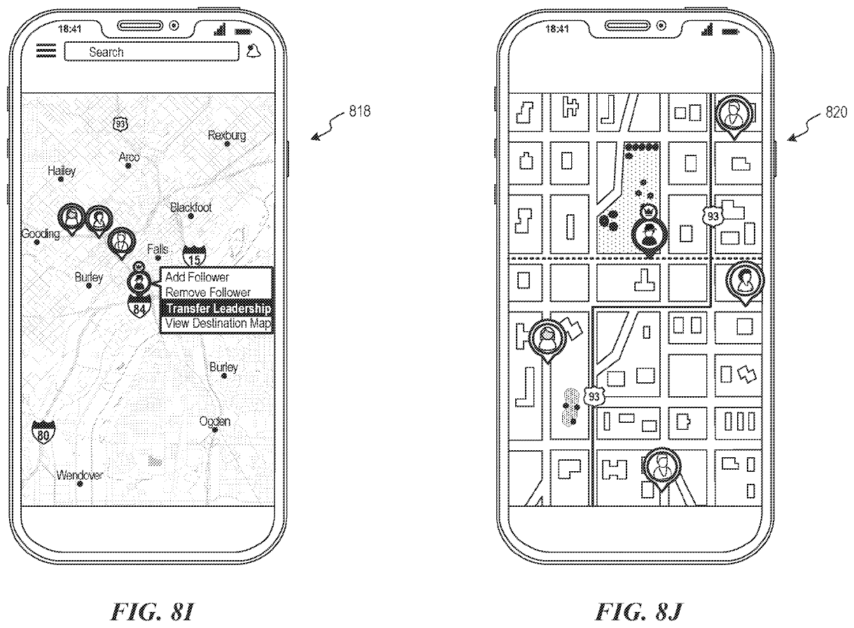

The process 500 begins at block 502 by creating a profile for the user (e.g., the group leader). Creating the profile can include receiving information about the user (e.g., name, contact information, and the like), emergency contact information, safety preferences, a user passcode or password (referred to collectively as a user's passcode), and the like. Purely by way of example, the user's safety preferences can be set to automatically alert the user and/or one or more emergency contacts if the user is in one location for more than a set period of time while tracking is on (which could indicate that, for example, the user is being held against their will at the location or has been forced to leave their phone). Purely by way of example, the process 500 can detect the user's arrival at a destination using GPS signals from their smartphone and automatically start a thirty-minute timer. If the user has not left (as indicated by the continuing GPS signals) by the end of the thirty minutes, the process 500 can automatically alert the user and/or any other suitable party. Alternatively, the process 500 can automatically detect a departure and either cancel the timer or prompt the user to confirm they intended to leave. In some embodiments, notification(s) sent to the user when a safety parameter is violated can prompt the user for their passcode information. The passcode information includes both a real passcode and a dummy passcode. The dummy passcode can be entered to secretly send an emergency message. In a specific, non-limiting example, when a user is in a location for longer than their set period of time, the system (e.g., any of the computing devices of FIGS. 1-3) can send them a notification requiring them to enter their password to snooze the alarm. When the user enters their real passcode, the alarm is snoozed. When the user enters their dummy passcode (or does not respond quickly enough (e.g., within one minute, two minutes, five minutes, ten minutes, or any other suitable period)), the system sends an emergency message to one or more of the user's emergency contacts and/or first responders (e.g., a security team, the police, 911, and/or any other suitable group). FIGS. 8A and 8B illustrate example user interfaces 802, 804 for receiving inputs from a user to create their profile and set safety settings in accordance with some embodiments of the present technology.

At block 504, the process 500 includes creating a group. The group can be created in response to inputs from the leader (e.g., providing phone numbers to invite users, the usernames of other users, and the like). Additionally, or alternatively, the leader can create a group that other users request to join (e.g., through the user's phone number, username, a scannable QR code, and the like). In some embodiments, the process 500 includes suggesting group members based on the proximity of other users to the leader (e.g., using GPS signals for each member to identify close members, using proximity signals communicated via a shortrange protocol, and the like). Once a group is created, the process 500 can share the location and/or current movement of group members with the other group members. In some embodiments, once a group is created, only the leader can disable the group. The quasi-permanent tether of the group can, for example, help track malicious group members. Purely by way of example, if a group member steals from another group member, they cannot leave the group to prevent their tracking. Further, as discussed in more detail below, the leader can set the malicious group member as the destination in order to receive a route to the malicious member and recover the stolen goods. FIG. 8C, for example, illustrates an example user interface 806 for receiving inputs from a user to add/invite group members in accordance with some embodiments of the present technology.

At block 506, the process 500 includes adding one or more destinations to the group. The destinations can be physical addresses (e.g., the addresses of homes that will be toured in a given day, bus stops and/or other drop-off/pick-up locations, stops for errands (e.g., grocery shopping), event spaces, restaurants, bars, and the like) that the group plans to visit. Additionally, or alternatively, the locations can be any of the members of the group. Purely by way of example, the leader can set themselves as a destination, thereby routing other group members to them. In another example, the leader can set any of the group members as a destination for one or more members of the group. Further, it will be understood that the process 500 can set varying destinations for various group members. In a specific, non-limiting example, the process 500 can set the leader as the destination for two group members, set another group member as the destination for two other group members, and set a physical address as the destination for a final group member. Such embodiments can be useful, for example, to subdivide destinations for members of a group. FIG. 8B, for example, illustrates an example user interface 804 for receiving inputs from a user to add destinations in accordance with some embodiments of the present technology.

At block 508, the process 500 includes optimizing a route to the destinations. For example, for a single destination, the process 500 can plan a route specific to each member of the group to reduce their travel time, maximize fuel efficiency, and/or coordinate the arrival of the group members (e.g., by picking a slower route for a member nearby the destination). In another example, when there are multiple destinations, the process 500 can order the destinations to reduce (or minimize) the travel time, mileage, or fuel costs to travel to all destinations. In some embodiments, the optimization can account for available times set for each destination (e.g., when a destination must be visited between 1:00 PM and 3:00 PM), a hierarchy of the destinations (e.g., prioritizing certain destinations), and/or external factors (e.g., temporal traffic patterns, ideal visit times, projected busyness at destinations, and the like). In a specific, non- limiting example, a real estate agent can input information indicating the ideal times to visit certain home showings to display neighborhoods and/or available windows for the home showings, and the process 500 can account for the information in planning the route. FIG. 8D illustrates an example user interface 808 for displaying destinations in an optimized order in accordance with some embodiments of the present technology.

At block 510, the process 500 includes sharing the route information with each of the group members. As discussed above, the route can be sent to the electronic device associated with each group member, allowing them to view the route, the position of other group members on the route, and/or any of the identified information. In embodiments where the destinations are physical addresses, the process 500 can also share information about each of the physical locations. Returning to the example above, the process 500 can share information about each of the homes (e.g., price, features, project commute time, and the like).

At block 512, the process 500 includes receiving input on the destinations and, at block 514, the process 500 includes updating the route based on the input. The input can be comments on the destinations, an indication that a destination should be removed or changed, and/or an indication that a different route is preferred. Returning again to the example above, the input can be comments (from the real estate agent and/or prospective buyers) regarding each home, inputs altering the order of the home showings (based on buyer preferences and/or order preferences from the real estate agent), an indication to remove a location (e.g., when the prospective buyers are not interested in a home), and the like. Additionally, or alternatively, the indications can add destinations, such as additional homes and/or sights nearby the homes (e.g., public parks, restaurants, grocery stores, and the like). Additionally, or alternatively, the indications can include a maximum amount of time that the group members want to spend at a location. For example, FIG. 8E illustrates an example user interface 810 for displaying destinations, displaying route information, displaying group member locations, and/or receiving inputs on the destinations and/or the route in accordance with some embodiments of the present technology. FIG. 8F illustrates an example user interface 812 for receiving user inputs on the destinations before beginning the route and/or after visiting destinations in accordance with some embodiments of the present technology.

With reference to FIG. 5, at block 516, the process 500 includes tracking the group members along the route. As discussed above, each group member's location and/or direction of travel can be tracked using GPS signals from the electronic devices associated with each member of the group and/or information from one or more beacons and/or other third-party devices. Additionally, or alternatively, other I/O components on the electronic devices can provide information to track each member of the group (e.g., accelerometer inputs, audio and/or video inputs, temperature inputs, and the like) and/or track the environment around the group member during their route. Each user's location, current route, and status can then be shared with the other group members while they are tethered. FIG. 8G, for example, illustrates an example user interface 814 for displaying a route and/or group member locations along the route in accordance with some embodiments of the present technology.

In some embodiments, the process 500 can record information from the group members as they travel. For example, the process 500 can record the milage traveled by individual group members, expenses incurred during travel, the number of destinations visited, the time spent at various locations, and/or any other suitable information. In a specific, non-limiting example, the record can allow a real estate agent to record their hours, milage, and/or the like with a real estate agency. Additionally, or alternatively, the record can allow prospective buyers to review the homes they visited, pictures they took at the homes, and/or notes they recorded at the homes.

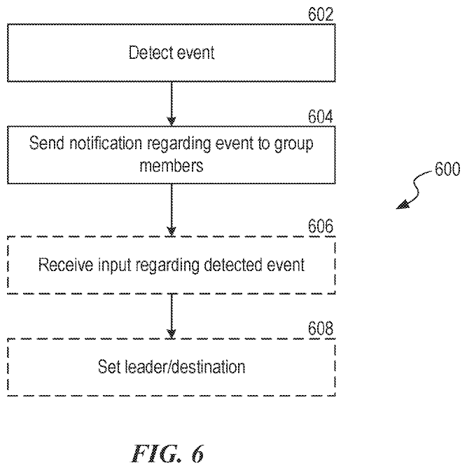

FIG. 6 is a flow diagram of a process 600 for reacting to detected events that can impact the safety of one or more members of the group in accordance with some embodiments of the present technology. The process 600 can be executed by any of the computing devices discussed above in response to inputs from one or more group members and/or their associated electronic devices.

The process 600 begins at block 602 by detecting an event. The process 600 can detect an event from one or more of the signal inputs discussed above. For example, the process 600 can detect a traffic accident involving (or in front of) a group member using GPS signals from the group member's electronic device (e.g., based on a sudden stop in movement). Additionally, or alternatively, travel information from one or more third-party devices can indicate an accident (e.g., GPS data from non-group members can indicate a rapid or sudden stop in movement indicating a traffic accident). In another example, the process 600 can detect an impact event (e.g., a dropped phone, a traffic accident, and/or the like) using an internal accelerometer, which can be associated with physical altercations and/or struggles (e.g., during a kidnapping, robbery, assault, and/or the like). In a related example, the process 600 can detect an event from audio inputs at the electronic device. In a specific example, the process 600 can use loud noises (e.g., shouts, screaming, booms, explosions, and the like), safety words and/or other cue words to detect an event, sirens, breaking glass, and the like. In yet another example, the inactivity of a group member beyond a preset time can indicate an event (e.g., that the group member is stuck behind traffic, being held by a malicious party, a group member's electronic device is dead and/or turned off, and the like).

At block 604, the process 600 includes sending a notification to one or more group members regarding the event. In some embodiments, the process 600 at block 604 is iterative. For example, a first notification can be sent to the group member regarding the detected event, allowing them to dismiss the event without alerting other members (e.g., when inactivity is due to a non-malicious cause, when an impact event is due to an accidental drop, and the like). In some embodiments, the process 600 requires the group member to enter a passcode to dismiss the event. For example, FIG. 8H illustrates an example user interface 816 for receiving a passcode in response to a detected event (e.g., exceeded timer at a location) in accordance with some embodiments of the present technology. As discussed above, the group member can have a valid passcode and a fake passcode, allowing the user to secretly send a notification dismissing the event if under duress (e.g., when a malicious party forces the user to enter the passcode thinking they are dismissing the event). The process 600 can then send a notification about the event to the other group members. In some embodiments, the process 600 at block 604 sends a notification about the detected event to all users at once. In such embodiments, the other group members can be more responsive to the event (e.g., thereby notifying group members immediately when another member is in a traffic accident rather than requiring the involved-member's response). Additionally, or alternatively, the other group members can dismiss the detected event on behalf of the involved user (e.g., when the involved group member accidentally broke their phone and can no longer respond to the detected event).

At optional block 606, the process 600 includes receiving one or more inputs related to the event. Purely by way of example, the group member involved in the event can add information related to the detected event before it is shared with the group (e.g., indicating that they are behind an accident and unharmed, that they will require assistance, and the like). In some embodiments, the process 600 can instruct the electronic device associated with the involved group member to gather additional information (e.g., to activate an audio and/or video feed, share additional GPS information, share emergency contact information, and the like). The responses from the electronic device are then received as inputs related to the event that can be saved and/or shared with other group members. Additionally, or alternatively, the process 600 can prompt electronic devices associated with other users for additional information. The prompt to other devices can allow other group members to provide an update to the information (e.g., providing a description when they witnessed a traffic accident, provide information regarding a detected stress event, and/or the like). In some embodiments, the description can be useful for first responders (e.g., a 911-dispatch) to respond appropriately to the detected event (e.g., dispatch an ambulance). Additionally, or alternatively, the prompt can instruct the electronic device associated with the other group members to gather additional information (e.g., to activate an audio and/or video feed, share additional GPS information, share emergency contact information, and the like).

At optional block 608, the process 600 includes setting a new leader and/or destination for one or more of the group members. Purely by way of example, the group member involved in the detected event can be set as a new leader (or new destination without leadership control) to route one or more group members to the involved member using GPS signals from the electronic device of the affected group member. The rerouting can allow the additional group members to respond to aid the involved group member (e.g., when they are in a traffic accident, when being kidnapped, and the like). Additionally, or alternatively, the group members can be routed to an alternative destination (e.g., a rest stop to wait for a group member caught behind an accident and/or who made one or more wrong turns, a hospital the group member is being sent to, a meeting location to regroup, and the like). The automatic rerouting can efficiently maintain a connection between a group while they travel, allowing members to aid each other in emergencies and/or helping ensure that no group members are left behind. The process 600 at block 608 can be generally similar to the process 400 discussed above with respect to FIG. 4. For example, the process 600 can include receiving GPS signals from one or more affected group members (e.g., the involved member and one or more members being rerouted), planning a route between the rerouted members and the involved member (or another suitable destination) based on their GPS signals and/or projected movement, sending the new route to each of the electronic devices of the affected members, then tracking each of the affected members along the new route. FIG. 8I illustrates an example user interface 818 for displaying a group member's locations along the route, transferring group leadership, and/or otherwise setting a new destination in accordance with some embodiments of the present technology. FIG. 8J illustrates another example of a user interface 818 for displaying group member locations while tethered in accordance with some embodiments of the present technology.

In some embodiments, the process 600 includes sharing the location of one or more of the group members with a third party in response to a detected event. For example, the process 600 can share the location of an affected group member in response to a detected traffic accident. Additionally, or alternatively, the process 600 can share the location of an affected group member with a first responder (e.g., police) in response to a detected altercation (which may be indicative of, for example, a kidnapping, assault, or other event requiring an immediate response).

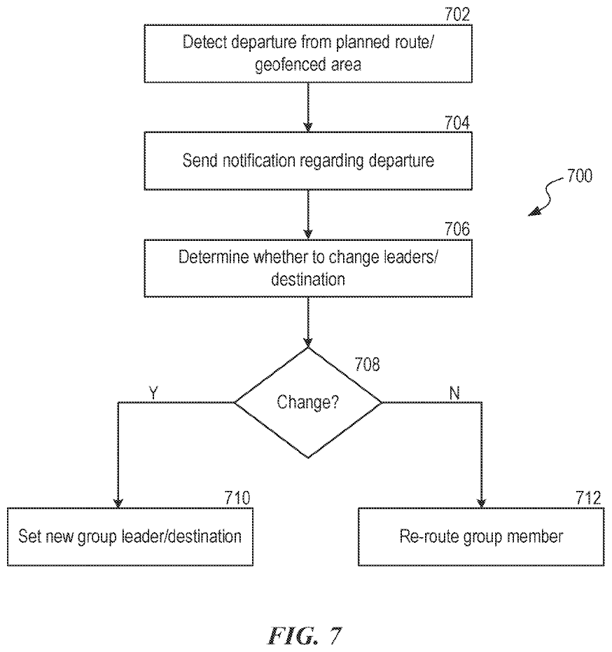

FIG. 7 is a flow diagram of a process 700 for reacting to a group member's departure from a planned route in accordance with some embodiments of the present technology. The process 700 can be executed by any of the computing devices discussed above in response to inputs from one or more group members and/or their associated electronic devices. As illustrated, the process 700 is generally similar to the process 600 discussed above with respect to FIG. 6. Further, although discussed in the context of responding to a departure from a planned route, it will be understood that the process 700 can be used to respond to a detected event in place of (or as a supplement to) the process 600 of FIG. 6.

The process 700 begins at block 702 by detecting a departure from the planned route by one or more of the group members. The process 700 can detect the departure while tracking each of the group members along a route using GPS signals from the electronic device associated with each member and/or signals from a beacon or other third-party device. In some embodiments, the departure is detected only after a deviation from the route by more than a predetermined threshold (e.g., GPS signals indicating the user is 50 feet off the route, 100 feet off the route, 500 feet off the route, or any other suitable distance; that the user missed a turn or exit; away from the route for more than a predetermined time such as ten seconds, thirty seconds, one minute, five minutes, ten minutes, half an hour, and/or any other suitable time; and the like).

At block 704, the process 700 includes sending a notification to one or more group members regarding the detected departure. In some embodiments, the process 700 at block 704 is iterative. For example, a first notification can be sent to the group member departing from the route, allowing them to dismiss the departure without alerting other members (e.g., when they are departing from the route to get gas, when a false departure is detected, and the like). In some embodiments, the process 700 can require the group member to enter a passcode to dismiss the departure. In some embodiments, the process 700 at block 704 sends a notification about the detected departure to all users at once. In such embodiments, the other group members can be more responsive to the departure (e.g., communicating with the group member regarding the departure). In some embodiments, the notification includes an audio/visual alert on the electronic device of each of the notified group members. In some embodiments, the notification is a visual indication on a map displaying the route for a group member and/or the location of all of the other users.

At block 706, the process 700 includes determining whether to change leaders for the group and/or the destination for one or more group members. The determination can be based on inputs from the group members (e.g., the explanation from the deviating member, inputs from the group leader, and the like). Additionally, or alternatively, the determination can be based on the magnitude of the deviation and/or whether there is any detected event associated with the deviation. Purely by way of example, a detection of shouting followed by a large deviation from the route could indicate that the electronic device for the deviating group member was stolen, which can impact the determination of whether to change the destination for one or more members (e.g., to pursue the thief, route to the last location for the group member before the deviation, and the like).

At decision block 708, if the process 700 determined to change leaders and/or the destination for one or more group members, the process 700 continues to block 710; else the process 700 continues to block 712.

At block 710, the process 700 includes setting a new group leader and/or a new destination for one or more group members. The process 700 at block 712 can be generally similar to the process 400 discussed above with respect to FIG. 4. For example, the process 700 can include receiving GPS signals from one or more affected group members (e.g., the deviating member and one or more members being rerouted; the last confirmed location for the deviating member and one or more members being rerouted; and the like), planning a route for the affected group members based on the GPS signals and/or projected movement, sending the new route to each of the electronic devices of the affected members, then tracking each of the affected members along the new route. In some embodiments, the group members can be directed to the deviating member without the original leader relinquishing control over the group. In some embodiments, the deviating member becomes a new leader for the group and gains some (or all) control over the group (e.g., an ability to set new destinations, add group members, and the like).

In some embodiments, the process 700 at block 710 includes sharing the location, based on GPS signals, of the affected group member with a third party. For example, the process 700 can share the location of the affected member with first responders (e.g., police) in response to a detected altercation (which may be indicative of, for example, a kidnapping, assault, or other event requiring a response) connected to the deviation. By sharing the real-time location of the group member with first responders, the process 700 can allow the first responders to quickly and effectively respond to a malicious event related to the deviation.

At block 712, the process 700 includes re-routing the deviating group member. The re-routing can adjust for the deviation from the planned route by directing the deviating member back to the route and/or planning a new route from the deviation point.

### C. Examples of Specific Implementations of the Present Technology

Specific implementations of the present technology are described below. However, one of skill in the art will understand that these are merely illustrative examples of the implementations rather than limiting examples. The present technology can be deployed in various other settings in accordance with any of the embodiments discussed above.

In one example, the present technology can be implemented in a real estate setting as an application that supports real estate agents. In this setting, a central server (e.g., a cloud server) can communicate with the smartphones associated with one or more real estate agents, their assistants, and prospective home buyers. For example, a real estate agent, through the server, can create a group, add their assistants and./or managers to the group for supervision, and add one or more prospective buyers (“buyers”) and/or related parties (e.g., friends or relatives touring homes with the buyers). The real estate agent can then add properties to a showing using their address, MLS number, other listing numbers, and/or from another suitable database of homes for sale.

The real estate agent can also add restrictions and/or show time information based on when a home is available for showing, best times to visit a neighborhood, typical traffic, planned stops, and the like, as well as any timer-based limitations (e.g., limiting each home showing to one hour for the safety of the real estate agent and/or to maintain pace during the showing). The server can then optimize a route for each of the homes (or receive a preferred route from the real estate agent) and share the route for the showing with each of the other group members.

The server can then receive feedback from the buyers on the homes listed (e.g., notes on the homes, removing a home the buyers are not interested in, or highlighting a home the buyers like, times the buyers would like to be at and/or spend at each of the homes, and/or any other suitable inputs). If any updates to the route are indicated by the inputs, the server can update the route accordingly and send the updated route to each of the group members.

In some embodiments, the homes can be listed as destinations in a route sent to the real estate agent while the buyer(s) are routed to the real estate agent with (or without) the homes displayed. This can allow the real estate agent to easily direct the buyers on a tour of the neighborhood around a home and/or points of interest (e.g., to show off restaurants, parks, grocery stores, a commuter route, bus stops and/or train stations, and the like). In some embodiments, the real estate agent and the buyers are routed to the homes as destinations independently. This can allow the server to optimize a route for both the real estate agent and the buyers based on their respective locations during the showing (e.g., when they start in different locations, make different turns along the route, and/or the like). Additionally, the routes can be dynamically updated during the showing (e.g., when the real estate agent and/or the buy make a wrong turn, when a home is added to the showing list, and the like). In some embodiments, both routes are shared with both the buyers and the real estate agent. As a result, for example, the real estate agent can see how close the buyers are to a location, when the buyers pass points of interest in the neighborhood, how long the buyers have been at a location, and the like.

In some embodiments, the server can automatically use the destinations (e.g., the homes), the routes generated, and/or estimated durations at each home to generate a calendar for the showings. The calendar can be shared with the buyers and the real estate agent to help visualize their day. Additionally, or alternatively, the calendar can be shared with a third party (e.g., the real estate agent's manager, a second buyer joining for only a portion of the showing, and the like) to help the third party track the group. The calendar can then be updated during the showing based on the location of the real estate agent, the location of the buyers, one or more changes to the destinations (e.g., an open house added to the showing, a home being removed, a detour for lunch, and the like), the actual time spent at the destinations, and/or the like.

During the showing, each of the group members can see the location of the other group members and/or an indication of how long they have been there. For example, when the buyers beat a real estate agent to a home, the real estate agent can see how long the buyers have been waiting. Additionally, or alternatively, the server can automatically retrieve and/or send information related to the location of the group members during a showing. For example, when the buyers arrive at one of the homes, the server can detect their arrival and automatically provide the buyers with information about the home (e.g., MLS numbers, prices, stats about a home, highlights, estimated monthly payments, estimated monthly taxes, time the home has been listed for, seller-ordered inspections, and the like). In another example, as the buyers travel along a route between homes, the server can use their tracked location to alert the buyers as they pass neighborhood highlights (e.g., well-rated restaurants, parks, and the like).

Additionally, or alternatively, a manager (or other related party) in the group can see how long the real estate agent has been at a home with the buyers. When the time exceeds some threshold (e.g., a safety threshold, a maximum amount of time the manager wants the real estate agent to spend at one home, and the like), the manager can contact the real estate agent to check in. Additionally, or alternatively, the server can automatically notify one or more group members when one group member exceeds a predetermined amount of time in one location. Further, during a showing, the server can receive information indicating an impact and/or other stress event. For example, the server can receive an indication from the real estate agent's electronic device (e.g., their smart phone) indicating a detected impact from the accelerometer on their electronic device. In some cases, the detected impact can be indicative of a struggle at the showing (e.g., with malicious buyers, robbers, and/or the like). Additionally, or alternatively, the detected impact can indicate an accident (e.g., a fall) during the showing. In a related example, the server can receive an indication from the real estate agent's electronic device indicating an argument based on loud noises recorded on their electronic device. The loud noises can be indicative of a struggle at the showing. When the server detects an event, the server can send a notification to one or more of the group members asking them to explain the detected event. For example, a notification can be sent to the real estate agent asking them to explain the detected impact. In response to the notification, the real estate agent can indicate that they need help, explain that they accidentally dropped their phone, and/or the like. In some embodiments, the notification requires the group members to input a passcode when responding to the notification, allowing the group members to discretely call for help by using a fake passcode. In response to an indication that one or more of the group members needs help, the server can notify another group member, a manager for the real estate agent, and/or a first responder.

Still further, as the group members travel between homes, they can see the location of the other members and/or be notified when a member deviates from the route. The deviation may indicate a planned stop (e.g., to grab a snack, gas, or water), a spontaneous stop (e.g., to look at an attraction in the neighborhood or an open house spotted on the route), an unplanned stop (e.g., a traffic accident), a missed or accidental turn, and the like. The notification can explain any delays to the other members and/or allow the other members to check in with the deviating member. In some cases, the other members can then be directed to the deviating member. For example, when the buyers spot an open house they would like to drop in on, the real estate agent can be automatically directed to the buyers and the open house.

In addition to tracking the location of the members during the route to share their location, the server can track and save statistics for the showing for later review. The statistics can include the number of homes seen during the showing, the number of miles traveled, the time spent at each home, the time spent during the showing, the time spent in the proximity of the buyers, expenses occurred during showing(s), and/or any other suitable statistic. These statistics can then be reviewed by the real estate agent, their manager, and/or any other suitable person to review and/or compensate the real estate agent and/or to identify successful strategies. For example, the server can study data from successful showings (e.g., showings that lead to a purchase) against unsuccessful showings to help identify an ideal number of miles traveled in a showing (for the real-estate agent and/or the buyers), total number of miles traveled before purchase, an ideal number of homes seen in a showing, total number of homes seen before a purchase, how much time the real estate agent should spend with the buyers, and the like.

Additionally, or alternatively, the server can receive inputs from the group members during the showing. For example, the inputs can include notes from the buyers on pros and cons they see in the homes during the showing, an indication of favorites, pictures of the homes, pictures and/or notes on nearby amenities and/or attractions related to various homes, and the like. Additionally, or alternatively, the inputs can include notes from the real estate agent, such as talking points discussed at the homes, follow up questions the buyers have about the homes, maximum prices the buyers would pay for one or more of the homes seen, and the like. The information can then be reviewed by the buyers and/or the real estate agent to help make a decision on the homes seen during the showing and/or to help plan homes for a future showing. In some embodiments, the server can record the route traveled during the showing and tag the information (photos, notes, etc.) with real-time locations along the route. As a result, the server can allow buyers to, for example, relive various points of a day.

In some embodiments, buyers and/or real estate agents can use the application to send information to the sellers of one or more homes. For example, during (or after) a showing, the buyers can use the application to send an offer to the sellers, inquire about additional related information (e.g., the availability of an inspection, and the like). Additionally, or alternatively, the application can allow the buyers (or real estate agent) to send and receive information from one or more third parties. For example, the application can allow the buyers to get pre-qualified (or qualified) for a loan on a home during (or after) the showing to visualize their monthly payments and/or facilitate making decisions.

In a related example, the application can be used by a real estate agent and/or buyers to tour homes in an open house setting. For example, the application can track the location of a real estate agent during a planned series of open houses and set a geofence around the locations during the open houses. If the location of the real estate agent indicates that they are breaking the geofence boundary, the application can prompt the real estate agent for an explanation (e.g., that they had to leave early, that the sellers requested ending the open house, that they were forced to leave by a malicious party, and the like). In some embodiments, the prompt can require the real estate agent to enter a passcode to dismiss the prompt and, in response to an incorrect or dummy passcode being entered, alert a third party (e.g., the real estate agent's manager, security, a first responder, and the like). In some embodiments, the alert shares a real-time location of the real estate agent with the third party.

Additionally, or alternatively, a buyers can use the application to visit and record open homes without the presence of a real estate agent. The homes can be input by the buyers and/or the real estate agent, along with an indication of preference for the homes, then the application can plan a route between the homes. In some embodiments, the application can identify multiple route options and present the options to the buyers. In some embodiments, the application can identify that the buyers will not be able to see every open house (e.g., based on the open house times, average visit times, travel times between the homes, and the like). In such embodiments, the application can prompt the buyers to choose between options on which homes to drop from the list.

While the buyers in this example visit homes, the application can share their location with a real estate agent and/or facilitate communications between the buyers and the real estate agent. For example, when the buyers visit a home they like, they can send information and/or questions on the home to their real estate agent through the application. The application can then share the notes, questions, and/or additional information (e.g., an MLS number) with the real estate agent. In some such embodiments, the MLS number shared with the real estate agent is automatically retrieved based on a location of the buyers. The location-based sharing can allow the buyers to drop in at open houses spontaneously along the route.

In another example of the present technology, groups can be created to allow parents to track their kids on a bus. For example, the parents can create a group with their kids to watch their location during the day. They can then instruct the server to automatically alert and/or route them to their kids when the kids get off at the wrong bus stop, when a bus breaks down, when a bus is at a bus stop and/or any other location for more than a preset period of time, when a bus is forced to deviate from the normal route, and the like. Additionally, or alternatively, the parents can monitor the bus's progress and time their arrival at the bus stop with the arrival of their kids. Additionally, or alternatively, the parents can see how long their children have been at the bus stop and/or how long the bus has been stopped in a specific location. They can then contact their kids for information on why the bus is stopped or to let them know they are running late. Additionally, or alternatively the parents can see (and/or be alerted) when their kids leave a bus stop. The vision can allow parents to track their children when they are picked up by a friend or other party, when they may be wandering away from a set location, and/or when they may be being taken by a malicious party. In some embodiments, for example, parents can set a geofence around a bus stop. Once the kid enters the geofenced area, the parents can receive an alert to their presence. If the child leaves the geofenced area, the parents can receive a notification and/or a real-time indication of their kid's location. In some such embodiments, parents can share the information and/or the location with one or more third parties (e.g., other parents, police or other first responders, and the like) allowing the third parties to help track and/or locate the kid.

Kids can also be shown the location of their parent(s). For example, when they are dropped off at a bus stop before their parent arrives, they can track the location of their parent to know they are on their way. Additionally, or alternatively, they can be routed to their parent when the parent cannot get to the bus stop, when they get off at the wrong bus stop, when the bus has deviated from the normal route, and the like.

Further, the event detection function can provide parents with additional information when an event is detected. Purely by way of example, when a traffic accident is detected, parents can be connected with an audio and/or video feed at the scene to assess whether their kid is alright or in need of medical attention, the severity of the traffic accident, and any lingering hazards. The audio/video feed can also provide parents with information/evidence if their kid is harmed.

Additionally, or alternatively, the present technology can allow parents, a school administrator, and/or another suitable party (e.g., a manager for a third-party bus company) to track statistics for bus drivers. Purely by way of example, the present technology can track the route taken by the bus driver, the speed along the route, driving patterns in high traffic areas and/or around known traffic stops (e.g., stop signs), how long the bus spends at bus stops, and the like. Any of the associated parties (parents, school administrators, and the like) can set safety parameters (e.g., bus cannot exceed the speed limit along the route, bus cannot deviate more than 100 feet from the route, bus cannot be stopped anywhere for more than five minutes, and the like). The group tracker can then use the GPS information from the bus driver to automatically detect when the safety parameters are violated and notify the associated party.

In another, related example, groups of friends and/or families can join a group when traveling together. In a specific example, a family can be grouped together while at a theme park (or other event center), allowing parents to track the location of their kids throughout the day. In some embodiments, the tracking can include creating a geofence around one of the parents (e.g., ten yards, twenty yards, fifty yards, one hundred yards, or any other suitable distance around a parent) and/or an area of the theme park. If one of the kids exits the geofenced area, the parents can be alerted, shown the current location of the kid, and provided with a route to the kid. The route can account for a current direction of travel (e.g., predicting where the kid will be in five minutes), allowing the parent to take shortcuts to catch up with the kid. Additionally, or alternatively, the kid can be alerted to their deviation and provided with a route back to their parent. Still further, the group members can be connected to communicate through the server. The communication can allow the parents to check in on their kid and/or coordinate on a destination to reunite at. Additionally, or alternatively, if any of the kids exits a geofenced area without an explanation from one of the group members, the application can automatically alert a third party (e.g., security, police, an emergency contact, and the like). As a result, for example, park security can be alerted to help return a child to their parents.

In another specific example, a group of friends can join a group while traveling, going out for drinks, hiking, skiing, and the like. For example, while traveling, each member of the group can add destinations (e.g., various sights, restaurants, the hotel, and the like). The server can then plan (or help plan) a route for each of the friends and provide the route to one or more of the friends to direct them to the destinations. Some of the friends can be daisy-chained together (e.g., a first friend is provided with directions to the destinations, a second friend is provided with directions to the first friend, a third friend is provided with directions to the second friend, and so on). The daisy chain can allow a single group member to be responsible for the destinations while the remaining friends are directed to each other to maintain the group. Additionally, or alternatively, the daisy chain can allow one or more of the friends to skip a destination (e.g., skip a sight), then receive directions to rejoin the group in between destinations. Additionally, because the route displays the current location of group members, the friends can track each other throughout the travel to check-in, monitor the status of their friends for safety purposes, easily meet up, see what others are experiencing, and the like. In a related example, when friends group together while going out for drinks, the group can monitor the safety and location of their friends to make sure no one is left behind and/or leaves without an explanation (e.g., leaves with a stranger). In some embodiments, the friends can set a geofence around a suitable destination (e.g., within 100 yards of the group leader and/or a set restaurant). If any of the friends exit the geofenced area, the other members of the group can be automatically alerted and routed to the deviating member. Additionally, or alternatively, if any of the friends exits the geofenced area without an explanation from one of the group members, the application can automatically alert a third party (e.g., police, an emergency contact, and the like). As a result, for example, a friend that did not go out for drinks (e.g., a designated driver that stayed home) can be provided with the location of the deviating member to retrieve the deviating member. Additionally, or alternatively, the police can be provided with the location of the deviating member during a suspected kidnapping and/or assault.

In another related example of the present technology, the group tracking application can be implemented with an open world map. In the open world map, a person's contacts (or a designated subset of their contacts) can see the location of the person (and vice versa) on a map. The person can then select one of their contacts as a destination (e.g., designating the contact as a group leader) and be routed to their contact and/or the person can set themselves as a destination (e.g., as a group leader) to provide their contact with a route to them. The route can be dynamically updated as the person and/or their contact move around. For example, the route can be updated to track the group leader as they move, project a future location of the group leader (e.g., based on their movement and/or an indicated destination), compensate for a wrong turn by the follower, and/or the like. The open world implementation can allow, for example, friends to discover each other at an event (e.g., a music festival, convention, city park, outdoor park, ski resort, and the like) and form ad hoc groups and/or meet up at the event. Additionally, the open world implementation can show that a group of friends is already grouped, allowing a new friend to join and be routed to the group. In some embodiments, the open world implementation can allow users to be discoverable to people outside of their contacts. In such embodiments, the open world implementation can allow users to discover other users looking to form groups. In a specific, non-limiting example, a solo concert goer can use the open world implementation to identify a group to join at the concert and be provided with a route to the group. Further, because the application can group the members together, the application can identify the grouped members to emergency contacts in case something happens to the solo concert goer. As a result, the solo concert goer can have increased social interaction at the concert and/or be provided with increased safety at the event (e.g., other members to look out for them). In another specific example, a solo skier can use the open world implementation to find one or more ski partner for the day while at the resort and be routed to their partner(s). As a result, the solo skier's safety during their trip is improved (e.g., because they are with someone in case of an accident).

In yet another example of the present technology, the group tracking can be used by an auto dealership to allow prospective buyers to test drive cars on their own. In this example, the prospective buyers are grouped with a member of the auto dealership and then are allowed to take a car for a test drive on their own. While grouped, the prospective buyers are tracked and their location is displayed to the member of the dealership. At any point in time, the member of the dealership can designate the prospective buyer(s) as a destination and be routed to the prospective buyer (e.g., when malicious activity is suspected, in response to an SOS from the buyer, in response to an accident, and the like).

Further, in this example, the group tracking can record statistics for use by the dealership, such as the mileage of the prospective buyer(s) during the test drive, the route they drove, the speeds they drove at, whether the prospective buyer(s) came to a compete stop at stop signs, behavior in high traffic areas, and the like. The statistics can provide the dealership and/or any associated insurance company with data to use against the buyer (or in defense of the buyer) in the case of an accident. Additionally, or alternatively, the dealership can set a geofence for the test drive. The group tracker can then detect the test drive exiting the geofenced area, automatically alert the dealership, and/or plan a route to the prospective buyer.

### D. Examples

Several aspects of the present technology are set forth in the following examples. Although several aspects of the present technology are set forth in examples directed to systems and methods, these aspects of the present technology can similarly be set forth in examples directed to methods and systems, respectively, in other embodiments. Additionally, these aspects of the present technology may be set forth in examples directed to devices and/or (e.g., non-transitory) computer-readable media in other embodiments.
1. A method for directing a plurality of group members to a leader, the method comprising:
   receiving a continuous stream of first global positioning system (GPS) signals from a mobile device associated with the leader;
   determining a real-time position of the leader using the continuous stream of first GPS signals; and
   for each individual member in the plurality of group members:
      receiving a continuous stream of second GPS signals from a mobile device associated with the individual member;
      determining a real-time position of the individual member using the continuous stream of second GPS signals;
      planning a dynamically changing route from the individual member to the leader based at least partially on the real-time position of the individual member and the real-time position of the leader; and
      sending the dynamically changing route to the mobile device associated with the individual member.
2. The method of example 1 wherein the dynamically changing route is updated at least every one hundred microseconds, every second, every ten seconds, or every minute.
3. The method of example 1 wherein the dynamically changing route is updated continuously during a navigation period.
4. The method of any of examples 1-3 wherein the plurality of group members and the leader are members of a total group, and wherein the method further comprises sending. to each member of the total group, an indication of a real-time position of each other member in the total group.
5. The method of any of examples 1-4 wherein the dynamically changing route is configured to be displayed on a map at the mobile device associated with the individual member.
6. The method of any of examples 1-5 wherein the leader is an original leader, and wherein the method further comprises:
   receiving, from the mobile device associated with the original leader, an indication to update the dynamically changing route to direct the plurality of members to a new leader;
   receiving a continuous stream of third GPS signals from a mobile device associated with the new leader;
   determining a real-time position of the new leader using the continuous stream of third GPS signals; and
   for each of the individual members in the plurality of group members:
      updating the dynamically changing route from the individual member based at least partially on the real-time position of the new leader; and
      sending the updated dynamically changing route to the mobile device associated with the individual member.
7. The method of any of examples 1-6, further comprising:
   detecting an event associated with a first member of the plurality of group members;
   determining the real-time position of the first member using third GPS signals from the mobile device associated with the first member; and
   for each of the individual members in plurality of group members and the leader:
      planning a new dynamically changing route to the first member based at least partially on the real-time position of the first member; and
      sending the new dynamically changing route to the mobile device associated with the individual member or the leader.
8. The method of example 7 wherein the detected event is at least one of:
   an impact alert;
   a rest stop;
   a deviation to a new destination;
   a timer-based event at a location;
   a deviation outside of a geofenced area; or
   an SOS signal.
9. The method of any example 7, further comprising receiving, from the mobile device associated with the first member, one or more inputs associated with the detected event.
10. The method of any of examples 1-9, further comprising:
   receiving, from the mobile device associated with the leader, inputs related to a maximum time for the leader to spend in a defined location;
   detecting, based on the real-time position of the leader, when the leader arrives at the defined location; and
   in response to detecting the leader arriving at the defined location, starting a timer.
11. The method of example 10, further comprising:
   when the timer reaches the maximum time for the leader to spend in the defined location, sending a notification to the leader prompting one or more inputs related to exceeding the maximum time.
12. The method of example 10, further comprising:
   when the timer reaches the maximum time for the leader to spend in the defined location, sending a notification to a third party related to the leader exceeding the maximum time at the defined location.
13. A method, comprising:
   receiving first global positioning system (GPS) signals from a mobile device associated with a lead member of a group including a plurality of members;
   determining an absolute position of the lead member using the first GPS signals; and
   for each individual member in the group other than the lead member:
      receiving second GPS signals from a mobile device associated with the individual member;
      determining an absolute position of the individual member using the second GPS signals;
      planning a route from the individual member to the lead member based at least partially on the absolute position of the individual member and the absolute position of the lead member; and
      sending the route to the mobile device associated with the individual member.
14. The method of example 13 wherein the absolute position of the lead member is a first absolute position of the lead member, and wherein the method further comprises:
   receiving third GPS signals from the mobile device associated with the lead member, wherein the first GPS signals are associated with a first time, and wherein the third GPS signals are associated with a second time later than the first time;
   determining a second absolute position of the lead member using the first GPS signals at the second time; and
   projecting a third absolute position of the lead member at a third time based at least partially on a difference between the first absolute position of the lead member and the second absolute position of the lead member,
   wherein, for each of the individual members in the group, the route from the individual member to the lead member is further based at least partially on the third absolute position of the lead member.
15. The method of example 13 or example 14, further comprising receiving, from the mobile device associated with the lead member, a planned route for the lead member, and wherein:
   the absolute position of the lead member indicates a position of the lead member along the planned route; and
   for each of the individual members in the group, the route from the individual member to the lead member is further based at least partially on the planned route.
16. The method of any of examples 13-15, further comprising receiving, from the mobile device associated with the lead member, a destination for the lead member, wherein, for each of the individual members in the group, the route from the individual member to the lead member is further based at least partially on the destination.
17. The method of any of examples 13-16, further comprising, for each of the individual members in the group:
   receiving third GPS signals from the mobile device associated with the individual member after sending the route to the mobile device associated with the individual member; and
   detecting a deviation from the route based on the third GPS signals.
18. The method of example 17, further comprising, for the individual member with the detected deviation:
   planning a new route from the individual member to the lead member based at least partially on the third GPS signals associated with the detected deviation; and
   sending the new route to the mobile device associated with the individual member.
19. The method of any of examples 13-18, further comprising:
   detecting an event associated with a first member of the plurality of group members;
   determining an absolute position of the first member using third GPS signals from the mobile device associated with the first member received contemporaneously with the detected event; and
   for each of the individual members in the group and the lead member:
      planning a new route to the first member based at least partially on the absolute position determined from the third GPS signals; and
      sending the new route to the mobile device associated with the individual member or the lead member.
20. A method, comprising:
   receiving, from a computing device associated with a group leader from, one or more destinations for a group having a plurality of group members;
   receiving a continuous stream of first global positioning system (GPS) signals from the mobile device associated with the group leader;
   determining a first position of the group leader using the continuous stream of first GPS signals;
   planning a first route from the first position to each of the one or more destinations;
   sending the first route to the mobile device associated with the group leader; and
   for each other individual member in the plurality of group members:
      receiving a continuous stream of second GPS signals from a mobile device associated with the individual member;
      determining a second position of the individual member using the continuous stream of second GPS signals;
      sending the second position of the individual member to the mobile device associated with the leader and a mobile device associated with other individual member in the plurality of group members;
      planning a second route from the individual member to each of the one or more destinations;
      sending the second route to the mobile device associated with the individual member, the mobile device associated with the group leader, and the mobile device associated with other individual member in the plurality of group members; and
      sending the first route and the first route to the mobile device associated with the individual member.
21. The method of example 20 wherein the destination is associated with a geofence boundary, and wherein the method further comprises:
   detecting, for a first individual member from the plurality of group members, when the first member is within the geofence boundary based on the continuous stream of second GPS signals; and
   sending a notification, to the mobile device associated with the group leader, indicating the first individual member is present at the destination.

### E. Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within ten percent of a given value or limit. Purely by way of example, an approximate ratio means within a ten percent of the given ratio. Still further, embodiments of the present technology sometimes refer to using GPS signals to determine an “absolute position” (or an “exact position”) of one or more persons and/or destinations. It will be understood, however, that the absolute position may incorporate a margin of error (sometimes referred to as global average user range error (URE)). For example, the absolute position may be accurate within about ten meters, within about five meters, within about one meter, and/or within any other suitable margin of error.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A method for directing a plurality of group members to a leader, the method comprising:
receiving a continuous stream of first global positioning system (GPS) signals from a mobile device associated with the leader;
determining a real-time position of the leader using the continuous stream of first GPS signals; and
for each individual member in the plurality of group members:
receiving a continuous stream of second GPS signals from a mobile device associated with the individual member;
determining a real-time position of the individual member using the continuous stream of second GPS signals;
planning a dynamically changing route from the individual member to the leader based at least partially on the real-time position of the individual member and the real-time position of the leader; and
sending the dynamically changing route to the mobile device associated with the individual member.

2. The method of claim 1 wherein the dynamically changing route is updated at least every second.

3. The method of claim 1 wherein the dynamically changing route is updated continuously during a navigation period.

4. The method of claim 1 wherein the plurality of group members and the leader are members of a total group, and wherein the method further comprises sending, to each member of the total group, an indication of a real-time position of each other member in the total group.

5. The method of claim 1 wherein the dynamically changing route is configured to be displayed on a map at the mobile device associated with the individual member.

6. The method of claim 1 wherein the leader is an original leader, and wherein the method further comprises:
receiving, from the mobile device associated with the original leader, an indication to update the dynamically changing route to direct the plurality of members to a new leader;
receiving a continuous stream of third GPS signals from a mobile device associated with the new leader;
determining a real-time position of the new leader using the continuous stream of third GPS signals; and
for each of the individual members in the plurality of group members:
updating the dynamically changing route from the individual member based at least partially on the real-time position of the new leader; and
sending the updated dynamically changing route to the mobile device associated with the individual member.

7. The method of claim 1, further comprising:
detecting an event associated with a first member of the plurality of group members;
determining the real-time position of the first member using third GPS signals from the mobile device associated with the first member; and
for each of the individual members in plurality of group members and the leader:
planning a new dynamically changing route to the first member based at least partially on the real-time position of the first member; and
sending the new dynamically changing route to the mobile device associated with the individual member or the leader.

8. The method of claim 7 wherein the detected event is at least one of:
an impact alert;
a rest stop;
a deviation to a new destination;
a timer-based event at a location;
a deviation outside of a geofenced area; or
an SOS signal.

9. The method of any claim 7, further comprising receiving, from the mobile device associated with the first member, one or more inputs associated with the detected event.

10. The method of claim 1, further comprising:
receiving, from the mobile device associated with the leader, inputs related to a maximum time for the leader to spend in a defined location;
detecting, based on the real-time position of the leader, when the leader arrives at the defined location; and
in response to detecting the leader arriving at the defined location, starting a timer.

11. The method of claim 10, further comprising:
when the timer reaches the maximum time for the leader to spend in the defined location, sending a notification to the leader prompting one or more inputs related to exceeding the maximum time.

12. The method of claim 10, further comprising:
when the timer reaches the maximum time for the leader to spend in the defined location, sending a notification to a third party related to the leader exceeding the maximum time at the defined location.

13. A method, comprising:
receiving first global positioning system (GPS) signals from a mobile device associated with a lead member of a group including a plurality of members;
determining an absolute position of the lead member using the first GPS signals; and
for each individual member in the group other than the lead member:
receiving second GPS signals from a mobile device associated with the individual member;
determining an absolute position of the individual member using the second GPS signals;
planning a route from the individual member to the lead member based at least partially on the absolute position of the individual member and the absolute position of the lead member; and
sending the route to the mobile device associated with the individual member.

14. The method of claim 13 wherein the absolute position of the lead member is a first absolute position of the lead member, and wherein the method further comprises:
receiving third GPS signals from the mobile device associated with the lead member, wherein the first GPS signals are associated with a first time, and wherein the third GPS signals are associated with a second time later than the first time;
determining a second absolute position of the lead member using the first GPS signals at the second time; and
projecting a third absolute position of the lead member at a third time based at least partially on a difference between the first absolute position of the lead member and the second absolute position of the lead member,
wherein, for each of the individual members in the group, the route from the individual member to the lead member is further based at least partially on the third absolute position of the lead member.

15. The method of claim 13, further comprising:
receiving, from the mobile device associated with the lead member, a planned destination for the lead member;
planning a route for the lead member from the absolute position of the lead member to the destination; and
sending the planned route to the mobile device associated with the lead member,
wherein, for each of the individual members in the group, the route from the individual member to the lead member is further based at least partially on the planned route.

16. The method of claim 13, further comprising:
for each of the individual members in the group, receiving third GPS signals from the mobile device associated with the individual member after sending the route to the mobile device associated with the individual member; and
for a first individual member from the individual members, detecting a deviation from the route based on the third GPS signals.

17. The method of claim 17, further comprising, for the individual member with the detected deviation:
planning a new route from the first individual member to the lead member based at least partially on the third GPS signals associated with the detected deviation; and
sending the new route to the mobile device associated with the first individual member.

18. The method of claim 13, further comprising:
detecting an event associated with a first member of the plurality of group members;
determining an absolute position of the first member using third GPS signals from the mobile device associated with the first member received contemporaneously with the detected event; and
for each of the individual members in the group and the lead member:
planning a new route to the first member based at least partially on the absolute position determined from the third GPS signals; and
sending the new route to the mobile device associated with the individual member or the lead member.

19. A method, comprising:
receiving, from a computing device associated with a group leader, one or more destinations for a group having a plurality of group members;
receiving a continuous stream of first global positioning system (GPS) signals from the mobile device associated with the group leader;
determining a first position of the group leader using the continuous stream of first GPS signals;
planning a first route from the first position to each of the one or more destinations;
sending the first route to the mobile device associated with the group leader; and
for each other individual member in the plurality of group members:
receiving a continuous stream of second GPS signals from a mobile device associated with the individual member;
determining a second position of the individual member using the continuous stream of second GPS signals;
sending the second position of the individual member to the mobile device associated with the leader and a mobile device associated with other individual member in the plurality of group members;
planning a second route from the individual member to each of the one or more destinations;
sending the second route to the mobile device associated with the individual member, the mobile device associated with the group leader, and the mobile device associated with other individual member in the plurality of group members; and
sending the first route and the first route to the mobile device associated with the individual member.

20. The method of claim 19 wherein the destination is associated with a geofence boundary, and wherein the method further comprises:
detecting, for a first individual member from the plurality of group members, when the first member is within the geofence boundary based on the continuous stream of second GPS signals; and
sending a notification, to the mobile device associated with the group leader, indicating the first individual member is present at the destination.
